(19) United States
(12) Patent Application Publication
(10) Pub. No.: US 2013/0279684 A1
(43) Pub. Date: Oct. 24, 2013

(54) COMMUNICATION DEVICE ANSWERING ENHANCEMENT SYSTEM AND METHOD

(71) Applicant: Mark R. Gregorek, (US)

(72) Inventors: Mark R. Gregorek, Ramsey, NJ (US); Jeffrey C. Dillow, Ramsey, NJ (US)

(73) Assignee: Mark R. Gregorek, Ramsey, NJ (US)

(21) Appl. No.: 13/868,875

(22) Filed: Apr. 23, 2013

Related U.S. Application Data
(60) Provisional application No. 61/687,403, filed on Apr. 23, 2012.

(51) Int. Cl. H04M 7/12

(52) U.S. Cl. CPC H04M 7/129
USPC 379/257

(57) ABSTRACT

An answering enhancement system originating on a called-party's communication device and working in conjunction with other resident software and hardware that becomes operational once the called-party's communication device is connected to an incoming call through a communication link. The answering enhancement system is not a part of or a function of the communications network. Once activated by a communications transmission, the answering enhancement system may instruct the called-party's communication device to play media files to calling-party or to the called-party by acting on associations pre-selected by the called-party. The media files may be played or displayed to the calling-party in replace of a conventional audible call progress signal or ringback tone and to the called-party as a ringtone and/or visual alert. The system allows the called-party to access the call and converse with calling-party as it normally would. After the media files have played for a pre-determined period of time the call may be transferred to a voicemail recording system residing in the called-party's communication device or network voicemail recording system for later retrieval. The media files may then be played or displayed to the calling-party as a voicemail announcement.

### CROSS-REFERENCE TO RELATED APPLICATIONS

This application claims benefit of provisional application Ser. No. 61/687,403, filed Apr. 23, 2012, the entire contents of the entire chain of applications are herein incorporated by reference.

### BACKGROUND OF THE INVENTION

The present invention relates to the general field of communication devices, and specifically to call answering enhancement systems and methods originating on communication devices.

The communication device answering enhancement system and method provides the benefits described herein over other answering systems and methods that are network based and require significant expense and complexity. Traditionally, while a calling communication device is attempting to contact another communication device, a ringing tone is sounded to alert a called party, while a ringback tone or other call progress signal is sounded to alert a calling-party, of the potential connection between the communication devices. In order to customize ringback tones in prior systems, a user must rely on network provided and enabled customization options. The present invention allows for a device originating answering enhancement system.

### SUMMARY OF THE INVENTION

The present invention provides an enhanced alert system originating from a called-party's communication device, whereby the called-party's communication device will connect to an incoming call and play or display media files, that may consists of audio, video, image, text, sfx files or any other media files known or understood to be used in the art, to either the calling-party or the called-party. The called-party then has the option to interact with the calling-party or to allow the media files to continue to play until the call is passed to an answering system or the call is abandoned. A device originating answering system or voicemail recording system may also access media files for use as the answering system's pre-recorded announcement. The called-party can select specific media files to associate with specific individuals, groups of individuals, networks, dates, holidays, events, or specific or random calling numbers via the called-party's communication device or via other internet enabled devices that can remotely control, modify or otherwise interact with the called-party's communication device.

The system comprises a communication device answering enhancement system, which is capable of delivering pre-recorded media content, such as audio, video, image, text or sfx files to calling-parties from a media source such as a terminal communication device or through connected storage devices such as a “cloud storage” (i.e. directly from a communication device or indirectly through cloud storage or other media storage devices). The cloud storage is preferably controlled by the called-party (directly or indirectly through an authorized third party, etc.) and the called-party's communication device preferably has access to the cloud storage.

The pre-selected media file associations are simple software commands used to determine what pre-recorded content is played in response to specific calling-parties or incoming calls. For example, a pre-selected media file association might specify that a certain pre-recorded media file, such as “A New York State of Mind” is to be played to all known or unknown calling-parties calling from the “212” exchange, or any other New York City, area code. The same association may specify that the same or a different pre-recorded media file be played as a ringtone and/or visual alert to the called party. Another pre-selected media file association might specify the playing of “Jingle-Bells” to all calling-parties pre-identified in a group as immediate family members, calling on December 25^{th}. That same association may specify that “Home for the Holiday's” be played to the called-party as a ringtone.

The communication device that uses this system may be a wireless, hand-held, transportable, or mobile device, including any mobile phone, smart phone, mobile internet device, or any other mobile device known in the art, and may have any other properties which are known or understood in the field to be embodied in a communication device. In an alternative embodiment, the communication device may include a computer, hardware or software within a computer, a remote storage center, soft-client, internet protocol phone, internet protocol switching system (e.g., IP PBX and the like), or any combination thereof. The communication device may be part of a voice over IP (“VoIP”) phone system for use in either commercial or residential purposes.

The communication device answering enhancement system may be accessed and utilized via hard or soft keys on a called-party's communication device, an attachable keypad or keyboard, a voice-activated speech recognition module, or any other known input means known in the art, or a combination thereof. It is also envisioned that the system can be accessed remotely to set or modify associations between media files and calling-parties without the called-party's communication device via any other internal enabled device. The pre-recorded media content or media files may consist of audio, video, image, text or sfx files or any other known or understood media file type used in the art (“media files”). The media file may be associated within the system with a calling-parties' network address, a calling number, or any other identifying characteristic of the calling-party chosen and available to the called-party's communication device. Media file associations can be made through interactions with a range of software, software applications, or applications resident or available on a communication device. Media file associations may be made or modified via a website interface connected via the communication device, cloud storage, a computer, another storage device, or any combination thereof. The called-party may select a desired media file association, or some other programming material, that can be played or displayed to either the calling-party or on the called-party's communication device.

The communication device, which allows a called-party to make media file associations, may consist of or have access to a memory or storage containing the media files as well as a means to select the specific identifiers of the calling-party that a called-party may wish to associate with the calling-party. The communication device may also have the ability to access the system to receive and create media file associations. The software may use a code to identify the components of the media file association (i.e., media file and identifier of the calling-party) and transmit this information from a called-party's communication device or other preselected device such as a computer or other pre-identified remote terminal. Software may reside on the communication device, within an application on the communication device, on a website application, or be accessed from a remote station or associated station or any combination thereof.

The system allows a called-party to select a desired media file and identifier of calling-party. The called-party may select the desired media file manually via hard keys, soft keys, attachable keyboard, attachable keypad, or remotely by any means known in the art. Additionally, media files, phone numbers and network addresses may be selected by speaking orally to a called-party's communication device. Predetermined voice commands directed towards the communication device can be translated to common phonemes by the communication device software allowing selection. The system may play or display the associated media file to the calling-party or on the called-party's communication device whenever that selected network address or telephone number is identified as calling and is connected to the called-party's communication device. In another embodiment, the called-party may select media files to be played or displayed as a default media file for the calling-party or on the called-party's communication device. For example, such a default media file may be played or displayed if the calling-party is unknown, if the called-party did not assign any associations to the incoming call or the calling-party, or if the called-party's communication device does not contain a means for identifying the caller.

The system is capable of allowing a called-party to modify the associations between media files and identifiers of callers (or revert to conventional tones) directly from the called-party's communication device in the same manner the original association was made. The system can play or display a newly associated media file to the calling-party or on the called-party's communication device whenever the incoming call is from the selected identifier of caller. For example, the communication device's called-party who knows that one of their frequent calling-parties has an affinity for University of Notre Dame might modify the media file associated ringtone for that frequent calling-party with a clip of Notre Dame's school song. That same association may also play the Notre Dame school song as a ringback tone to the called-party or it could choose to have another media file specified.

An initial connection is established by the called-party's communication device having the enhanced answering system. The initial connection allows the system to act on associations between identifier of calling-party and media files, and to subsequently play or display the associated media files to the called-party or calling-party. Following the identification of the association between the identifier of calling-party and media files, the media files may be played or displayed to the desired party for a pre-determined period of time. During this time, the called-party may access the communication line or link as would be done normally (such as by pressing answer or lifting a receiver) and may converse or interact with the calling-party at any point.

The system can transmit the identity of the calling-party to the communication device, allowing the called-party the option of canceling or circumventing the playing or displaying of the media file to the calling-party by immediately answering the call. A called-party may also have the option of canceling, ignoring, or circumventing the playing or displaying of the media file on her communication device at transmittal of the incoming calling-party's identity. Additionally, the system may permit the called-party the option of allowing the media file to play or display for a pre-determined time and then hand off the incoming call to a voice recording storage file or voicemail. The called-party may interrupt the media file by answering the incoming call to converse with the calling-party at any point in the pre-determined time. The announcement for the voice recording storage or voicemail may also be selected from various media files for specific identified callers.

The present invention is not limited to the transfer of media files from one communication device to a second, and may be used in other applications. For example, the present invention may be embodied as an advertisement device. The called-party may send media files to calling-parties in replace of a conventional ringback tone or answering the call for the purpose of advertising or delivering any commercial message. For example, a called-party could customize direct advertising messages of its business based on the geographical location, phone number or network address of the calling-party, or other known identifiers of the calling-party. Such associations need not be made by manual input from a called-party, but rather may be programmed via software for multiple or mass associations of many calling-parties by, for example, third parties.

The called-party using the system may be a subscriber who uses the services based on a monthly service fee. A called-party may also have purchased the system from a middleware provider or service provider, to integrate into its communication device or communication system. The system may be preinstalled or downloaded on the communication device as an application.

### BRIEF DESCRIPTION OF THE DRAWINGS

A further understanding of the invention can be obtained by reference to a preferred embodiment as set forth in the illustrations of the accompanying drawings. Although the illustrated embodiment is merely exemplary of systems for carrying out the invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the specific methods and instrumentalities disclosed.

For a more complete understanding of the invention, reference is now made to the following drawings in which:

FIG. 1 is a block diagram in accordance with the communication device answering enhancement system of the present invention;

FIGS. 2A, 2B and 2C are flow diagrams depicting one embodiment of the system where a calling-party and called-party are played media files;

FIG. 3 is a flow diagram depicting another embodiment of the system where a calling-party is played media files; and

FIG. 4 is a flow diagram depicting another embodiment of the system where a called-party is played media files.

### DETAILED DESCRIPTION OF THE PREFERRED EMBODIMENT

A detailed description of the preferred embodiments of the present invention is described below with reference to the figures. However, techniques, systems, and operating structures in accordance with the invention may be embodied in a wide variety of forms and modes, some of which may be quite different from those in the disclosed embodiment. Consequently, the specific structural and functional details disclosed herein are merely representative, yet in that regard, they are deemed to afford the best embodiment for the purposes of disclosure and to provide a basis for the claims herein, which define the scope of the invention. The following presents a detailed description of a preferred embodiment (as well as some alternative embodiments) of the invention.

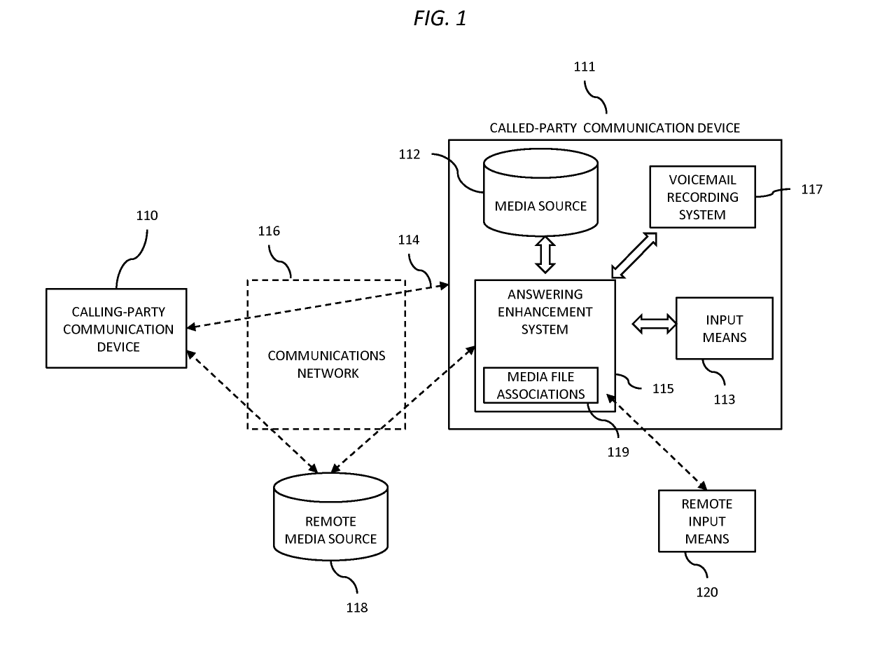

Referring to the drawings wherein like numerals indicate like elements throughout, in one embodiment there is shown in FIG. 1 a block diagram in accordance with the communication device answering enhancement system of the present invention. The present invention provides an answering enhancement system 115 originating on a called-party communication device 111 for playing or displaying media files to a calling-party or called-party on communication devices 110 and 111. The media files may be played or displayed to the calling-party on the calling-party communication device 110 in replace of a call signal generated by the communications network 116, such as a call progress signal or tone, ringback signal or tone, a busy signal or tone, a network redirect signal or tone, a network announcement signal or tone, or a dial tone signal. The media files may also be played or displayed to the calling-party on communication device 110 as a voicemail announcement. In addition, the media files may be further played or displayed to the called-party on the called-party communication device 111 as a call notification signal, such as a ringtone, visual alert, a call waiting signal or tone, or the like.

The called-party of communication device 111 receives an incoming call from a calling-party of communication device 110 via a communications network 116. The invention is designed for use with any type of communications network 116, including any network capable of transmitting audio, video, data, image, text, sfx files, or multimedia files, as well as interactive, or hybrid information, programming material, or any other media files. The communications network 116 may comprise a circuit-switched network, a packet-based network, the Internet, a local area network, a wide area network, a virtual private network, a metropolitan area network, a broadcast network, a wireless network, or a cellular network, or other like networks. The communications network 116 provided by these network providers may utilize wireless, facilities-based, satellite-based, hybrid types of transmission schemes and/or mechanisms, or other systems of similar function.

Each communication device 110 and 111 that uses the system of the present invention may be a wireless, cellular, hand-held, transportable, or mobile device, a telephone, a video telephone, any mobile phone, smart phone, mobile internet device, a mobile computer, a personal digital assistant, multimedia handset, a tablet computer, or any other mobile device known in the art, and may have any other properties which are known or understood in the field to be embodied in a communication device. In an alternative embodiment, each communication device 110 and 111 may include a computer, hardware or software within a computer, a remote storage center, soft-client, internet protocol phone, internet protocol switching system (e.g., IP PBX and the like), or any combination thereof. The communication devices 110 and 111 may be part of a voice over IP (“VoIP”) phone system for use in either commercial or residential purposes.

The media files may consists of audio, video, data, image, text, sfx files, or multimedia files, as well as interactive, or hybrid information, programming material, or any other media files known or understood to be used in the art. The media files may be stored on a storage device, such a media source 112 directly on the called-party communication device 111 or on a remote media source 118, such as cloud storage, network server, application server, media server, dedicated ringback or ringtone server, or a third-party server. The remote media source 118 is preferably controlled by the called-party (directly or indirectly through an authorized third party) and the called-party communication device 111 preferably has access to the remote media source 118.

The answering enhancement system 115 preferably uses media file associations 119 to determine what media file to play to the calling-party and/or to the called-party when the calling-party initiates a call to the called-party. The media file associations 119 are preferably pre-selected by the called-party and consist of simple software commands. The software may reside on the called-party communication device 111, within an application on the called-party communication device 111, on a website application, or be accessed from a remote station or associated station or any combination thereof. The pre-selected media file associations 119 may associate at least one media file with at least one parameter. The at least one parameter may include a calling-party identifier, such as a calling-party's network address, IP address, SIP, URI, or a phone number, any other identifying characteristic of the calling-party, a group of calling-parties, specific or random calling numbers. The at least one parameter may alternatively, or in addition, include a geographic location, an area code, a date, a range of dates, a time of day, a time period, a holiday, an event, or a combination thereof. The software may use codes to identify the components of the media file association (i.e., the media file and at least one parameter). The media file associations 119 may include a look-up table which stores information about which media file is linked to which parameter.

When the called-party communication device 111 receives an incoming call from the calling-party communication device 110, it completes a communications link 114 with the incoming call. The answering enhancement system 115 may then identify information associated with the incoming call and cross reference that information with the stored parameters of the media file associations 119 to identify which media file to play or display to the calling-party and/or the called-party. The incoming call information may comprise the identity of the calling-party communication device 110, identified by the called-party communication device 111 or received from the network provider of communications network 116. The identity of the calling-party communication device 110 may be its phone number, network address, IP address, SIP, URI, or any other network addressing scheme. In turn, the answering enhancement system 115 may include a media file association 119 that associates the calling-party identifier, such as the called-party's phone number, with a particular media file. The answering enhancement system 115 may identify the media file to play or display by cross referencing the identity of the calling-party communication device 110 placing the incoming call with the stored identifier.

The incoming call information may alternatively, or in addition, comprise a geographic location of the calling party communication device 110, the area code of the calling-party communication device 110, a date of the incoming call, time of the incoming call, a holiday during the incoming call, or a combination thereof. For example, the answering enhancement system 115 may identify the media file to play or display by cross referencing the date of the incoming call (identified using the communication device's 111 or communications network's 116 calendar) with a stored specific date or range of dates associated with at least one media file. The answering enhancement system 115 may identify the media file to play or display by cross referencing the time of the incoming call (identified using the communication device's 111 or communications network's 116 clock) with a specific time or a time period associated with at least one media file. The answering enhancement system 115 may further receive geographic location of the calling-party communication device 110 determined by a global positioning system (GPS), area code, cellular towers, radio frequency triangulation, or other types of location determination known in the art. The answering enhancement system 115 may then identify the media file to play or display by cross referencing the geographic location of the calling-party communication device 110 with a stored specific location (or determine whether the calling-party is located within a stored area) associated with at least one media file.

In another embodiment, the answering enhancement system 115 of the present invention may comprise a default media file association, either preinstalled by the answering enhancement system 115 or selected by the called-party, to play or display a default media file on the calling-party or called-party communication devices 110 or 111. For example, such a default media file association may be triggered by the following parameters: if the calling-party is unknown, if the called-party did not assign any specific associations to the incoming call or the calling-party, or if the called-party communication device does not contain a means for identifying the caller.

The media associations 119 may be added or modified by the called-party via input means 113 associated with or connected to the called-party communication device 111, such as hard or soft keys, an attachable keypad or keyboard, a voice-activated speech recognition module, or any other known input means known in the art, or a combination thereof. In an alternative embodiment, media associations 119 may be modified through a remote input means 120, such as internet enabled devices that can remotely control, modify or otherwise interact with the called-party communication device 111. Media associations 119 may also be modified through website interface, cloud storage, computer, another storage device, or a combination thereof. The calling-party may create media file associations through interactions with a range of software, software applications, or applications resident or available on the communication device 111.

The answering enhancement system 115 of the present invention may be preinstalled or downloaded on the called-party communication device 111 as software or application. The called-party of the communication device 111 using the system may be a subscriber who uses the services based on a monthly service fee. A called-party may also have purchased the system from a middleware provider or service provider, to integrate into its communication device 111.

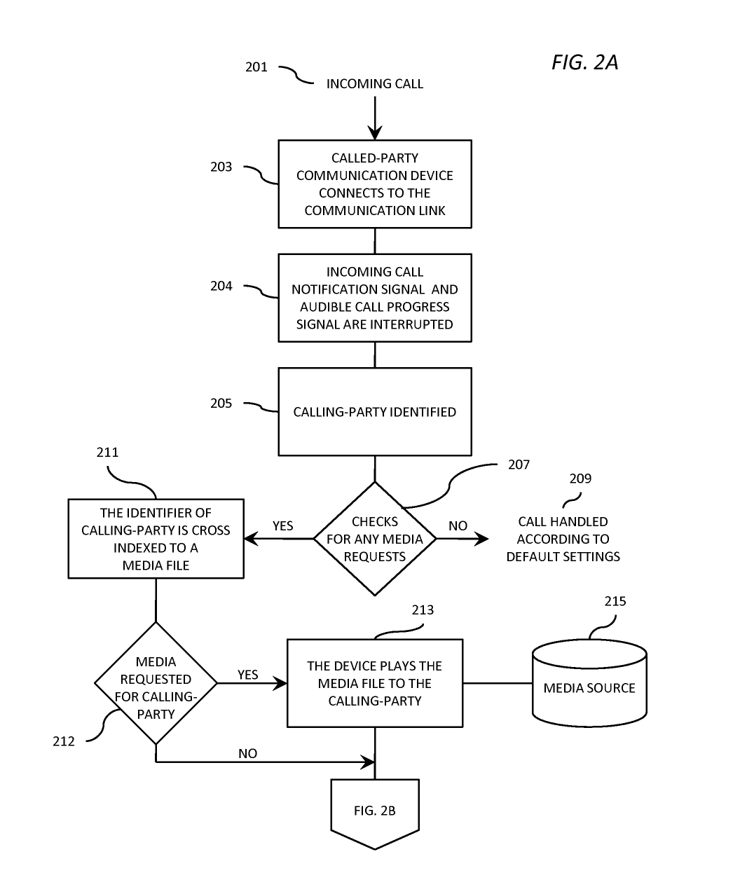

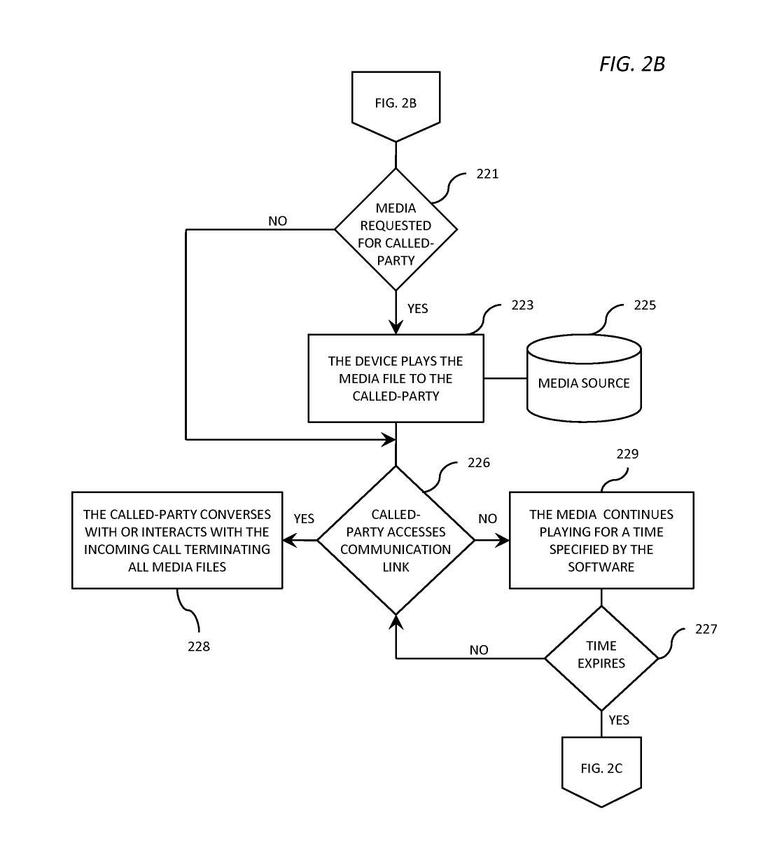

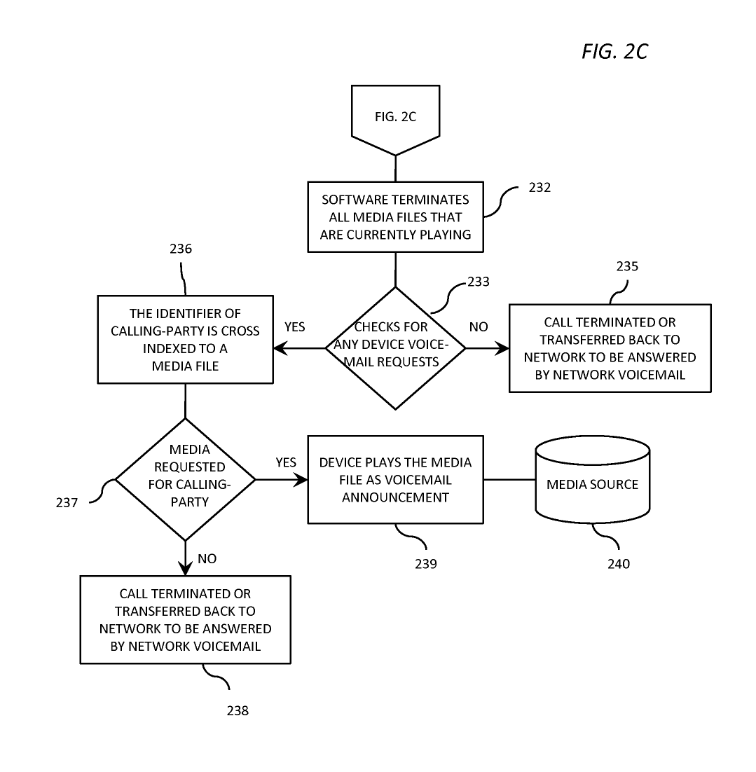

Referring to FIGS. 2A-2C, flow diagrams of one embodiment of the present invention are shown depicting the communication device answering enhancement system 115 where a calling-party and called-party are played media files. In step 201, an incoming call is received on a called-party communication device 111 from a calling-party communication device 110. The answering enhancement system 115 may cause the called-party communication device 111 to connect to the communication link 114 in step 203. The answering enhancement system 115 may interrupt the incoming call notification signal (or ringtone, visual alert, or call waiting signal or tone) to the called-party communication device 111 in step 204. The answering enhancement system 115 may also interrupt the audible call progress signal (or ringback signal or tone, a busy signal or tone, a network redirect signal or tone, a network announcement signal or tone, a dial tone signal, or the like) provided by the communications network 116 to the calling-party communication device 110 in step 204. The called-party communication device 111 may, for example, send a signal to the network provider of the communications network 116 to interrupt the call signal to the calling-party communication device 110. The called-party communication device 111 may also send a signal to the network provider of the communications network 116 to delay the ringback tone to the calling-party communication device 110. This brief delay, which spans nanoseconds and yields a pause undetectable by the unaided human ear, may allow the called-party communication device 111 to identify the calling-party communication device 110. The connection between communication devices 110 and 111 through the communication link 114 allows the called-party communication device's answering enhancement system 115 to act on media file associations 119 and play or display media files to the calling-party of communication device 110 or called-party of the communication device 111.

Following the initial connection between communication devices 110 and 111, the answering enhancement system software may compare a contact list residing in, or available to, a called-party communication device 111 with the identifier of the calling-party communication device 110 to identify the calling-party communication device 110 in step 205. Alternatively, the calling-party communication device 110 may receive the calling-party identification information from a communications network's 116 service provider, or from other source or device known in the art for identifying a calling-party. The calling-party communication device 110 may be identified, for example, by its network address, IP address, SIP, URI, phone number, or any other identifying characteristic of the calling-party known in the art. In step 207, the system 115 checks for any media requests present by checking if there are any pre-selected or default media file associations 119. If there are no media requests present, the call, including tones alerting both called-party and calling-party of communication between devices 110 and 111 and the resulting communication between devices 110 and 111 and parties, is handled according to default settings and proceeds as normal in step 209. If there are media requests present, the identifier of the calling-party communication device 110 may be cross indexed to a media file in step 211 based on media file associations 119. Cross-indexing at this point in the system functions to identify the associated media file requested to be played or displayed to the calling-party on communication device 110 based on the identifier of the calling-party communication device 110. As described above, the identifier of the calling-party may be the communication device's network address, IP address, SIP, URI, phone number, or any other identifying characteristic of the calling-party known in the art. The answering enhancement system 115 may also check whether there are media request based on other associations, for example, calling-party's geographic location, an area code, a date, a range of dates, a time of day, a time period, a holiday, an event, or combinations thereof, or a default media file association, if there are no specific associations present.

If there are no media files requested for the calling-party communication device 110 in step 212 (either based on a specific association or on default association), the system proceeds to FIG. 2B, to identify if there are any media requests for the called-party.

If there are media files requested for the calling party, the called-party communication device 111 may play or display the requested media file to the calling party on communication device 110 in replace of the audible call progress signal in step 213. The requested media file may be played in replace of any conventional tones. The source of the requested media files may be supplied by the device's storage 112 or remote storage 118, the internet, cloud storage, other software or any combination thereof in step 215. For example, the called-party communication device 111 may directly transmit the requested media file to the calling-party communication device 110. Alternatively, the answering-enhancement system 115 may cause the called-party communication device 111 to transmit a signal to instruct a remote media source 118 to transmit the requested media file to the calling-party communication device 110, by either transmitting the signal directly to the media source 119 or thorough a third-party, such as the communications network service provider.

Following the initial playing or displaying of the requested media files to the calling-party, the system progresses to FIG. 2B, where any media file requests for the called-party are identified in step 221 by checking if there are any pre-selected or default media file associations 119. However, it is contemplated that the requested media files may alternatively be first played or displayed to the called-party and then to the calling-party, or may be played or displayed to the calling-party or called-party communication devices 110 and 111 simultaneously. The media file associations 119 may associate a specific media file with specific calling-party, calling-party's network address, IP address, SIP, URI, or phone number, calling-party's geographic location, any other identifying characteristic of the calling-party, a group of calling-parties, specific or random calling numbers, an area code, a date, a range of dates, a time of day, a time period, a holiday, an event, or combinations thereof, or a default media file association to play or display a default media file on the called-party communication device 111 if there are no specific associations present. If there are no media files requests on the called-party communication device 111, the call proceeds with a conventional ringtone alerting the called-party of an incoming call.

If there are media files requests for the called-party, the communication device 111 may proceed to play or display the requested media file on the called-party communication device 111 in step 223. The played or displayed media file may replace the conventional or stock tone (or ringtone, visual alert, or a call waiting signal or tone) alerting the called-party of an incoming call. The source of these media files may also be supplied by the device's storage 112 or remote storage 118, the internet, cloud storage, other software or any combination thereof in step 225.

The called-party may or may not access the communication link 114 using the communication device 111 and converse with the incoming call in step 226. If the called-party accesses and interacts with the incoming call to converse with the calling-party, all playing media files are terminated for both the calling-party and called-party on communication devices 110 and 111 in step 228. The communication between devices 110 and 111 continues as normal, allowing each party to converse with the other.

If the called-party does not access the communication link 114 to converse or interact with the incoming call, the media files continue to play for a pre-determined amount of time that may be specified by software in step 229. The software may reside on the called-party communication device 111, may be transferred with the media file to the calling-party communication device 110, or may reside remotely, for example, on the remote media source 118 or on a server of the communications network service provider. The time specified by the software may be determined by the media file length, by the called-party, by duration of standard conventional tones alerting calling-party and called-party of communication between devices 110 and 111, or any combination thereof. During the playing or displaying of media files in the time-specified by the software, the called-party may access the communication link 114 and converse with the calling-party at any point resulting in termination of all media files playing or displaying, allowing conversation between parties to follow.

Incoming calls not accessed and thus not interacted with by a called-party during the time specified by the software result in the time expiring in step 227. Following expiration, as seen in FIG. 2C in step 232, all media files currently playing or displaying may be terminated and the system may proceed to the communication device voicemail recording options or device voicemail, such as the voicemail recording system 117. If there is no device originating voicemail recording option available, the call may be terminated or transferred back to the network to be answered by a conventional network voicemail recording system or network voicemail.

If there is a voicemail recording device option available, then the call is transferred to the called-party communication device's voicemail recording system 117. The answering enhancement system 115 checks for any media file requests present for device voicemail recording system 117 in step 233 by checking if there are pre-selected or default media file associations 119. If there are no media requests for the voicemail recording system 117, the call is terminated in step 235 or transferred back to the network to be answered by a conventional network voicemail recording system or network voicemail. Alternatively, the voicemail recording system 117 activates without playing any media files. If there are media requests present, the answering enhancement system 115 may cross-index the identifier of the calling-party communication device 110 to any associate media file to be played as a voicemail announcement in step 236. As described above, the identifier of the calling-party may be the communication device's network address, IP address, SIP, URI, phone number, or any other identifying characteristic of the calling-party known in the art. Alternatively, or in addition, the answering enhancement system 115 may check whether there are any media file requests present for the voicemail recording system 117 based on other associations, for example, calling-party's geographic location, an area code, a date, a range of dates, a time, a time period, a holiday, an event, or whether there is a default media file association. If there are no media files requested for the calling-party communication device 110, the call is terminated in step 238 or transferred back to the network to be answered by a conventional network voicemail recording system or network voicemail. Alternatively, the voicemail recording system 117 activates without playing any media files.

If there are media files requested for the calling-party, the called-party communication device 111 may play or display the requested media file to the calling party on communication device 110 as a voicemail announcement in step 239. Media files for voicemail announcements may also be supplied from the device's storage 112 or remote storage 118, the internet, the cloud or other software in step 240. For example, the called-party communication device 111 may directly transmit the requested media file to the calling-party communication device 110. Alternatively, the answering-enhancement system 115 may cause the called-party communication device 111 to transmit a signal to instruct a remote media source 118 to transmit the requested media file to the calling-party communication device 110, by either transmitting the signal directly to the media source 119 or through a third-party, such as the communications network service provider. Following the playing or displaying of the media files as a voicemail announcement in step 239, the calling-party may leave a message to be retrieved by the called-party at a later time.

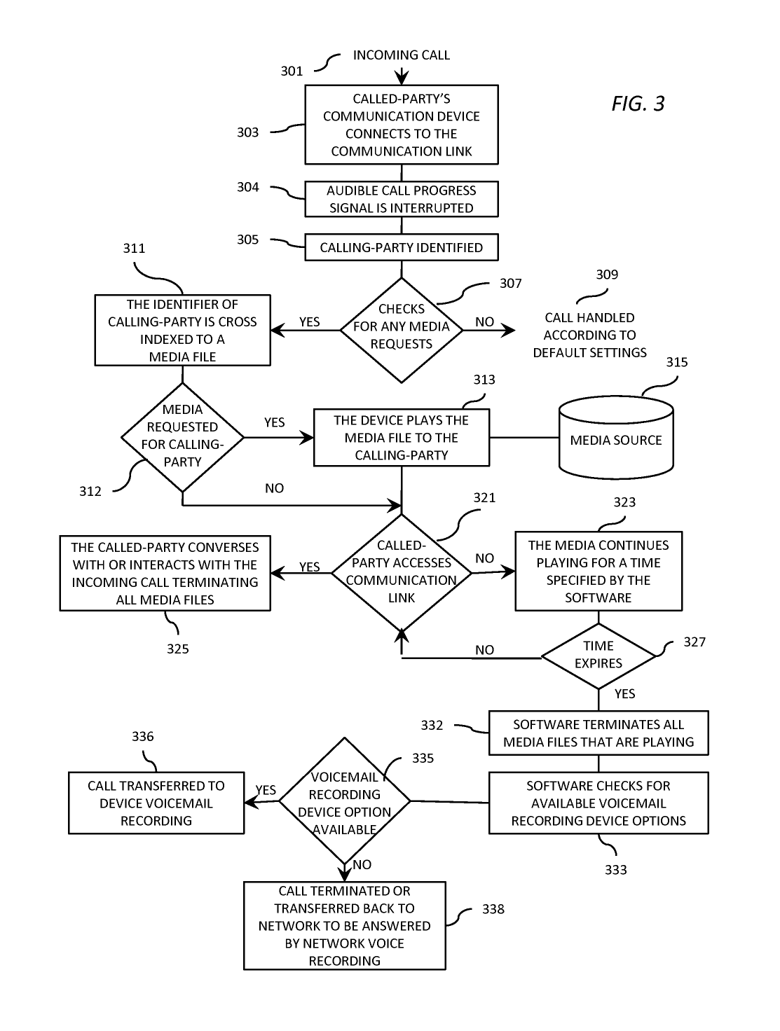

In a second embodiment, seen in FIG. 3, the system functions nearly the same as in the first embodiment except there are no media file requests or files selected to be played or displayed to the called party. For example, only the calling-party may experiences media files playing or displaying in place of a conventional ringback tone and/or as a voice recording announcement while the called party experiences a conventional ringtone.

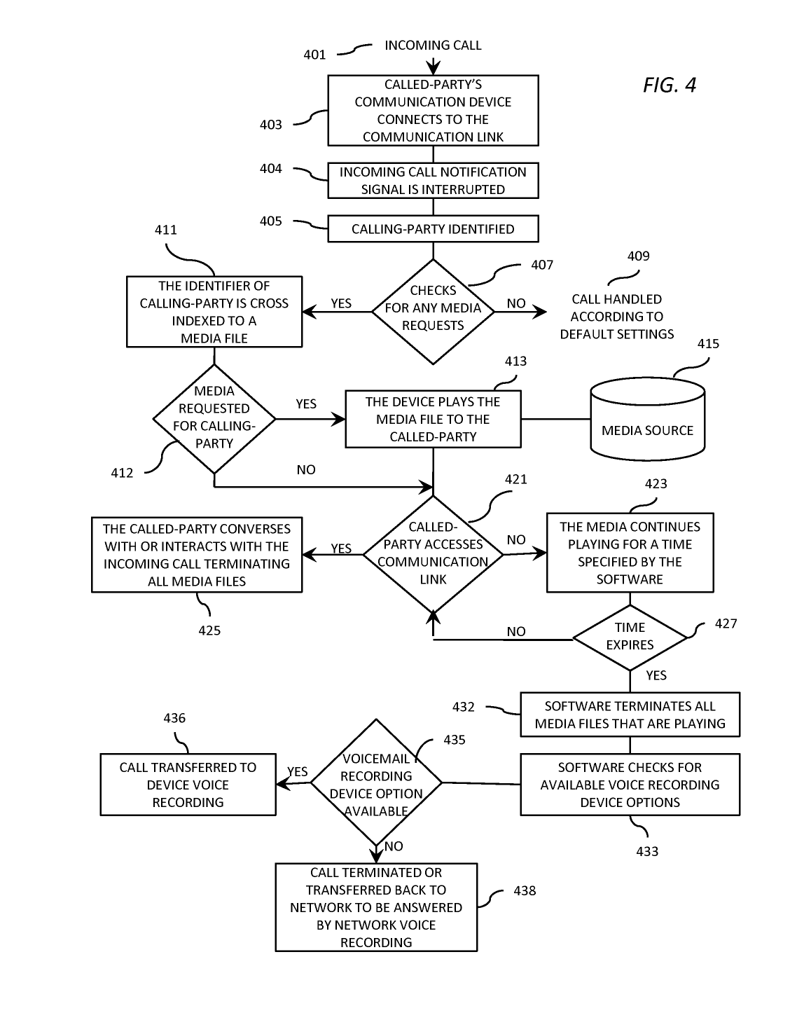

In a third embodiment, as seen in FIG. 4, the system functions nearly the same as the first embodiment; however, there are no media files selected to be played or displayed to the calling-party. For example, only the called-party may experience media files in place of a conventional ringtone, while the calling-party experiences a conventional ringtone or ringback tone.

In all preferred embodiments or any other embodiment, the media files played are not limited to a single file played per party. There may be multiple media files played in tandem, consecutively with another file, or any combination thereof.

While the present invention has been described with reference to the preferred embodiments, which have been set forth in considerable detail for the purposes of making a complete disclosure of the invention, the preferred embodiments are merely exemplary and are not intended to be limiting or represent an exhaustive enumeration of all aspects of the invention. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. A system for customizing a communications device connected to a communications network, the system comprising:
a first communication device associated with a called party;
a media file stored in a storage device accessible by said first communication device;
an identifier stored in the storage device accessible by said first communication device and associated with said media file, wherein said identifier identifies a second communication device associated with a calling party;
wherein said first communication device is configured to complete a communication link with an incoming call received from the second communication device, identify the second communication device, and identify said media file by cross referencing said identified second communication device with the stored identifier; and
wherein at least a portion of said identified media file is transmitted from said storage device to the second communication device as a call signal after the first communication device establishes communication with the second communication device but before the second communication device abandons the communication link or before the incoming call is answered by the first communication device.

2. The system of claim 1, wherein said incoming call is transmitted to a voicemail recording system and wherein at least a portion of said identified media file is transmitted from said storage device to said second communication device as a prerecorded voicemail announcement after the incoming call is transmitted to the voicemail recording system.

3. The system of claim 1, wherein said transmitted at least a portion of said identified media file is played or displayed to the calling party on the second communication device.

4. The system of claim 1, wherein at least a portion of said identified media file is played or displayed to the called party on said first communication device in place of an incoming call notification signal.

5. The system of claim 4, wherein said incoming call notification signal is selected from a group consisting of a ringtone and a visual alert.

6. The system of claim 1, wherein said call signal is selected from the group consisting of a call progress signal, a ringback tone, and an audible signal.

7. The system of claim 1, wherein said at least one media file is selected from a group consisting of an audio file, a video file, an image file, a text file, a sfx file, a programming material, an advertisement, or a combination thereof.

8. The system of claim 1, wherein said identifier of the second communication device is selected from the group consisting of a phone number, a network address, and an IP-based network address.

9. The system of claim 1, wherein the called party is a subscriber to said system.

10. The system of claim 1, wherein, the called party is a purchaser of the system from a middleware provider.

11. The system of claim 1, wherein, the system is installed on said second communication device.

12. The system of claim 1, wherein each of said first or said second communication devices is selected from the group consisting of a wireless device, a hand-held device, a transportable device, a mobile device, a telephone, a mobile phone, a smart phone, a mobile internet device, a computer, hardware within a computer, a remote storage center, a voice over IP phone, or a combination thereof.

13. A system for customizing a communications device connected to a communications network, the system comprising:
a first communication device associated with a called party;
a media file stored in a storage device accessible by said first communication device and associated with a parameter;
wherein said first communication device is configured to complete a communication link with an incoming call received from a second communication device associated with a calling party, identify information associated with the incoming call, and cross reference said incoming call information with the parameter;
wherein said media file is identified if said incoming call information matches said parameter; and
wherein at least a portion of said identified media file is transmitted from said storage device to the second communication device as a call signal after the first communication device establishes communication with the second communication device but before the second communication device abandons the communication link or before the incoming call is answered by the first communication device.

14. The system of claim 13, wherein said incoming call is transmitted to a voicemail recording system and wherein at least a portion of said identified media file is transmitted from said storage device to said second communication device as a prerecorded voicemail announcement after the incoming call is transmitted to the voice recording system.

15. The system of claim 13, wherein said transmitted at least a portion of said identified media file is played or displayed to the calling party on the second communication device.

16. The system of claim 13, wherein at least a portion of said identified media files is played or displayed to the called party on said first communication device in place of an incoming call notification signal.

17. The system of claim 16, wherein said incoming call notification signal is selected from a group consisting of a ringtone and a visual alert.

18. The system of claim 13, wherein said call signal is selected from the group consisting of a call progress signal, a ringback tone, and an audible signal.

19. The system of claim 13, wherein said at least one media file is selected from a group consisting of an audio file, a video file, an image file, a text file, a sfx file, a programming material, an advertisement, or a combination thereof.

20. The system of claim 13, wherein said stored parameter comprises a stored identifier that identifies the second communication device.

21. The system of claim 20, wherein said stored identifier is selected from the group consisting of a phone number, a network address, and an IP-based network address.

22. The system of claim 20, wherein said incoming call information comprises the identity of said second communication device.

23. The system of claim 22, wherein the media file is identified if said identity of the second communication device matches said stored identifier that identifies the second communication device.

24. The system of claim 13, wherein said stored parameter is selected from a group consisting of a geographic location, an area code, a date, a holiday, or a combination thereof.

25. The system of claim 13, wherein said incoming call information is selected from a group consisting of a geographic location of said second communication device, an area code of said second communication device, a date of the incoming call, a holiday during the incoming call, or a combination thereof.

26. The system of claim 13, wherein each of said first or said second communication devices is selected from the group consisting of a wireless device, a hand-held device, a transportable device, a mobile device, a telephone, a mobile phone, a smart phone, a mobile internet device, a computer, hardware within a computer, a remote storage center, a voice over IP phone, or a combination thereof.

27. A method for customizing a communications device connected to a communications network, the method comprising:
storing a media file in a storage device accessible by a first communication device associated with a called party;
associating said media file with a parameter;
completing, by said first communication device, a communication link with an incoming call received from a second communication device associated with a calling party;
identifying information associated with the incoming call;
cross referencing said incoming call information with said parameter;
identifying said media file if said incoming call information matches said parameter; and
causing at least a portion of said identified media file to be transmitted from said storage device to the second communication device as a call signal after the first communication device establishes communication with the second communication device but before the second communication device abandons the communication link or before the incoming call is answered by the first communication device.
